(19) United States
(12) Patent Application Publication
(10) Pub. No.: US 2003/0177005 A1
(43) Pub. Date: Sep. 18, 2003

(54) Method and device for producing acoustic models for recognition and synthesis simultaneously

(75) Inventors: Yasuyuki Masai, Kanagawa (JP); Yoichi Takebayashi, Kanagawa (JP); Hiroshi Kanazawa, Kanagawa (JP); Yuzo Tamada, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/388,491

(22) Filed: Mar. 17, 2003

(30) Foreign Application Priority Data
Mar. 18, 2002 (JP) 2002-074072

(51) Int. Cl. G10L 19/10; G10L 13/06

(52) U.S. Cl. 704/220

(57) ABSTRACT

An acoustic model production device simultaneously produces an acoustic model for recognition and an acoustic model for synthesis in good quality, by inputting speech data, extracting phoneme information from the speech data and setting the speech data and the phoneme information in correspondence, learning an acoustic model for recognition from the speech data and the phoneme information, and producing an acoustic model for synthesis from the speech data and the phoneme information.

### BACKGROUND OF THE INVENTION

1. Field of the Invention

The present invention relates to an acoustic model production device and an acoustic model production method to be used for the speech recognition (processing for converting speech data into text data) and the speech synthesis (processing for converting text data into speech data).

2. Description of the Related Art

There are many propositions for a method for producing the acoustic model to be used for the speech recognition and a method for producing the acoustic model to be used for the speech synthesis, and many speech recognition devices and the speech synthesis devices are commercially available. For instance, Toshiba manufactures and sells a software called “LalaVoice™ 2001” since the year 2000, which has both a speech recognition function and a speech synthesis function.

Conventionally, the acoustic model to be used for the speech recognition and the acoustic model to be used for the speech synthesis have been produced separately, and each one has a limited utilizability. Consequently, even when the data of the same speaker are used, the differences between the acoustic model for recognition and the acoustic model for synthesis could be caused by the differences in places or times of the utterances, despite of the fact that the models are to be made on the speeches of the same speaker, and it has been impossible to optimally produce both the acoustic model for recognition and the acoustic model for synthesis.

For example, suppose that the acoustic model for recognition was produced for some speaker, and then the acoustic model for synthesis was produced ten years later. Even if the text data converted from the speech data recorded at the time of producing the acoustic model for recognition are available, if the acoustic model for synthesis produced ten years later is used, it is impossible to synthesize speeches in the same voice as heard at the time of producing the acoustic model for recognition.

Also, from a viewpoint of the efficiency of the acoustic model production, the speech recognition and the speech synthesis have many parts of their processing and models that are common, so that the separate production of the acoustic models have been resulting in a lower efficiency. In future, it is expected that our society will require the conversion of a large amount of speech data into text data and the conversion of a large amount of text data into speech data, so that there is a demand for producing the acoustic model for recognition and the acoustic model for synthesis at high efficiency, in finegrained form.

### BRIEF SUMMARY OF THE INVENTION

It is therefore an object of the present invention to provide an acoustic model production device and an acoustic model production method capable of simultaneously producing the acoustic model for recognition and the acoustic model for synthesis in good quality.

According to one aspect of the present invention there is provided an acoustic model production device, comprising: a speech data input unit configured to input speech data; a phoneme information extraction unit configured to extract phoneme information from the speech data, and set the speech data and the phoneme information in correspondence; an acoustic model for recognition production unit configured to learn an acoustic model for recognition from the speech data and the phoneme information; and an acoustic model for synthesis production unit configured to produce an acoustic model for synthesis from the speech data and the phoneme information.

According to another aspect of the present invention there is provided an acoustic model production method, comprising: inputting speech data; extracting phoneme information from the speech data, and setting the speech data and the phoneme information in correspondence; learning an acoustic model for recognition from the speech data and the phoneme information; and producing an acoustic model for synthesis from the speech data and the phoneme information.

Other features and advantages of the present invention will become apparent from the following description taken in conjunction with the accompanying drawings.

### BRIEF DESCRIPTION OF THE DRAWINGS

FIG. 1 is a block diagram showing a configuration of an acoustic model production device according to the first embodiment of the present invention.

FIG. 2 is a flow chart showing one exemplary processing by an acoustic model production method according to the first embodiment of the present invention.

FIG. 3 is a flow chart showing another exemplary processing by an acoustic model production method according to the first embodiment of the present invention.

FIG. 4 is a block diagram showing an exemplary way of utilizing the acoustic model production device according to the first embodiment of the present invention.

FIG. 5 is a diagram showing an exemplary speech dialogue scene supposed in the exemplary way of utilizing shown in FIG. 4.

FIG. 6 is a block diagram showing a configuration of an acoustic model production device according to the second embodiment of the present invention.

FIG. 7 is a block diagram showing a configuration of an acoustic model production device according to the third embodiment of the present invention.

FIG. 8 is a block diagram showing a configuration of an acoustic model production device according to the fourth embodiment of the present invention.

FIG. 9 is a block diagram showing an exemplary way of utilizing the acoustic model for recognition and the acoustic model for synthesis produced by the acoustic model production device according to the fourth embodiment of the present invention.

### DETAILED DESCRIPTION OF THE INVENTION

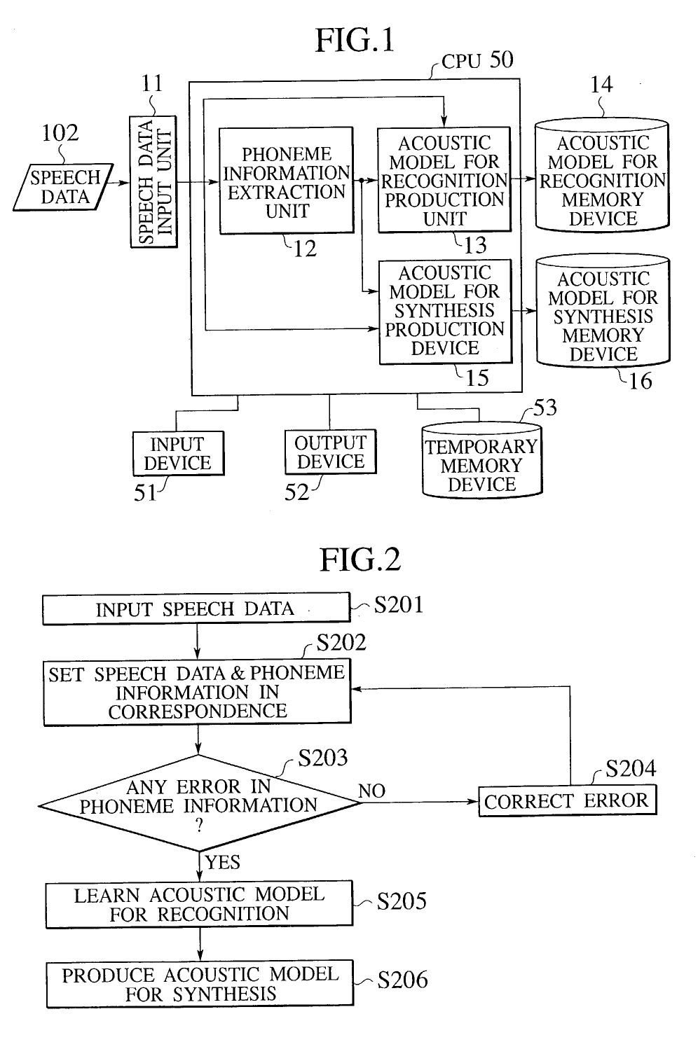

Referring now to FIG. 1 to FIG. 9, the first to fourth embodiments of the present invention will be described in detail. Note that, in the drawings, the same or similar elements are given the same or similar reference numerals. It should be noted that these drawings are schematic.

(First Embodiment)

The acoustic model production device according to the first embodiment has a configuration shown in FIG. 1, which has a speech data input unit 11 for inputting speech data 102, a CPU (processing control device) 50, an input device 51 connected to the CPU 50, an output device 52, a temporary memory device 53, an acoustic model for recognition memory device 14, and an acoustic model for synthesis memory device 16. The CPU 50 has a phoneme information extraction unit 12, an acoustic model for recognition production unit 13, and an acoustic model for synthesis production unit 15.

The speech data input unit 11 inputs the speech data 102 into the acoustic model production device. More specifically, the speech can be inputted directly by using a microphone or the speech data in forms of files can be inputted, but a specific form of input data are not relevant here. The phoneme information extraction unit 12 extracts phoneme information from the speech data 102, and sets the speech data 102 and the phoneme information in correspondence. This can be realized by converting the speech into the phoneme information by using the speech recognition device and setting the speech and the phoneme information in correspondence, for example. The speech recognition device can be using Toshiba's “LaLaVoice™ 2001” mentioned above. The automatically extracted result of the phoneme information extraction unit 12 can be displayed at the output device 52, and the only the correctly extracted phoneme information can be selected by the manual check using the input device 51.

The acoustic model for recognition production unit 13 carries out the learning of the acoustic model for recognition from the speech data and the phoneme information. There are many methods available as the acoustic model for recognition learning method, depending on the scheme of the acoustic model, such as the well known Baum-Welch algorithm in the case of using HMM, for example. The acoustic model for recognition memory device 14 stores the acoustic model for recognition produced by the acoustic model for recognition production unit 13. The acoustic model for recognition memory device 14 can be realized in various media such as semiconductor memory, hard disk, and DVD, but a specific form of the media to be used is not relevant here.

The acoustic model for synthesis production unit 15 produces the acoustic model for synthesis from the speech data and the phoneme information. What is to be produced can be different depending on the acoustic model to be used for the speech synthesis. For example, the phonemic element, fundamental pitch, sound source residual, meter information, etc., are produced for the inputted speech data. As an example, the method for producing the phonemic element will be described. A time window of a prescribed time length of about 20 msec is set on the speech data, and the cepstrum analysis is carried out within each window while shifting in a prescribed time of about 10 msec. Then, the cepstrum parameters are extracted from the frame range corresponding to the phoneme by using the power spectrum or the speech power of each frame, as the phonemic elements. Similarly as the acoustic model for recognition memory device 14, the acoustic model for synthesis memory device 16 can be realized in various media such as semiconductor memory, hard disk, and DVD, but a specific form of the media to be used is not relevant here.

The input device 51 is a device such as a keyboard, a mount, etc. When the input operation is carried out at the input device 51, the corresponding key information is transmitted to the CPU 50. The output device 52 is a display screen of a monitor or the like, which can be formed by a liquid crystal display (LCD) device, a light emitting diode (LED) panel, an electro-luminescence (EL) panel, etc. The temporary memory device 53 temporarily stores data used while the calculation or the analysis is carried out by the processing of the CPU 50.

According to the acoustic model production device of the first embodiment, it is possible to simultaneously produce the acoustic model for recognition and the acoustic model for synthesis in good quality.

Next, a processing flow of the acoustic model production device of the first embodiment will be described with reference to FIG. 2.

First, at the step S201, the speech data inputted by the speech data input unit 11 are recorded by the phoneme information extraction unit 12 into the temporary memory device 53. Then, at the step S202, the phoneme information extraction unit 12 extracts the phoneme information from the recorded speech data, and sets the speech data and the phoneme information in correspondence.

Next, at the step S203, whether there is any error in the phoneme information or not is judged. As a judgement method to be used, the phoneme information extraction unit 12 can automatically make a judgement by checking whether the reliability (score) of the extracted phoneme satisfies a prescribed condition or not. Also, the automatically extracted result can be displayed at the output device 52, and the judgement can be made manually.

When there is an error in the phoneme information, the processing proceeds to the step S204 to make the correction of the phoneme information. As a correction method to be used, the more detailed phoneme information extraction can be carried out even though it requires more processing time to improve the precision of the phoneme extraction, or the information of a portion that is judged as incorrect can be set as not to be used. Also, the automatically extracted result can be displayed at the output device 52, and the correct phoneme information can be inputted or only the correctly extracted phoneme information can be selected, manually by using the input device 51. Then, the processing returns to the step S202 to retry the extraction of the phoneme information.

When there is no error in the phoneme information at the step S203, the processing proceeds to the step S205 at which the acoustic model for recognition is learned from the speech data and the phoneme information by the acoustic model for recognition production unit 13.

Next, at the step S206, the acoustic model for synthesis is produced from the speech data and the phoneme information by the acoustic model for synthesis production unit 15.

According to the acoustic model production method described above, it is possible to simultaneously produce the acoustic model for recognition and the acoustic model for synthesis in good quality.

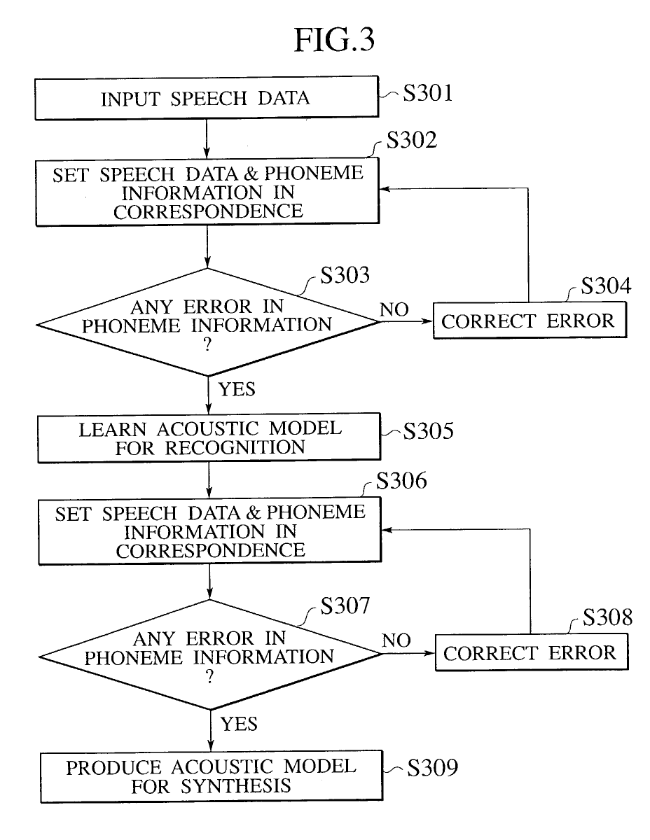

Next, another processing flow of the acoustic model production device of the first embodiment will be described with reference to FIG. 3.

The steps S301 to S305 are the same as the steps S201 to S205 of FIG. 2 so that their description will be omitted here.

Next, at the step S306, the phoneme information extraction unit 12 extracts the phoneme information from the speech data by using the acoustic model for recognition learned at the step S305, and sets the speech data and the phoneme information in correspondence. By utilizing the acoustic model for recognition, it becomes possible to extract the phoneme information more accurately.

Next, at the step S307, whether there is any error in the phoneme information or not is judged. As a judgement method to be used, the phoneme information extraction unit 12 can automatically make a judgement by checking whether the reliability (score) of the extracted phoneme satisfies a prescribed condition or not. Also, the automatically extracted result can be displayed at the output device 52, and the judgement can be made manually.

When there is an error in the phoneme information, the processing proceeds to the step S308 to make the correction of the phoneme information. As a correction method to be used, the more detailed phoneme information extraction can be carried out even though it requires more processing time to improve the precision of the phoneme extraction, or the information of a portion that is judged as incorrect can be set as not to be used. Also, the automatically extracted result can be displayed at the output device 52, and the correct phoneme information can be inputted or only the correctly extracted phoneme information can be selected, manually by using the input device 51. Then, the processing returns to the step S306 to retry the extraction of the phoneme information.

When there is no error in the phoneme information at the step S307, the processing proceeds to the step S309 at which the acoustic model for synthesis is produced from the speech data and the phoneme information by the acoustic model for synthesis production unit 15.

According to the acoustic model production method described above, it is possible to simultaneously produce the acoustic model for recognition and the acoustic model for synthesis in good quality, and it is possible to extract the phoneme information more accurately.

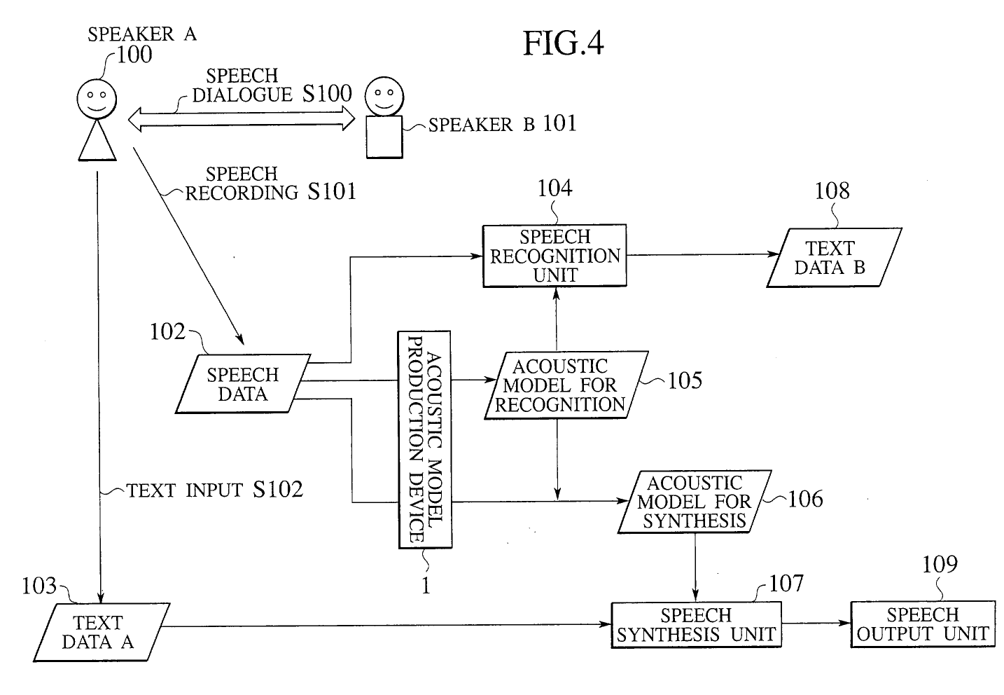

Next, an exemplary way of utilizing the acoustic model production device according to the first embodiment will be described with reference to FIG. 4.

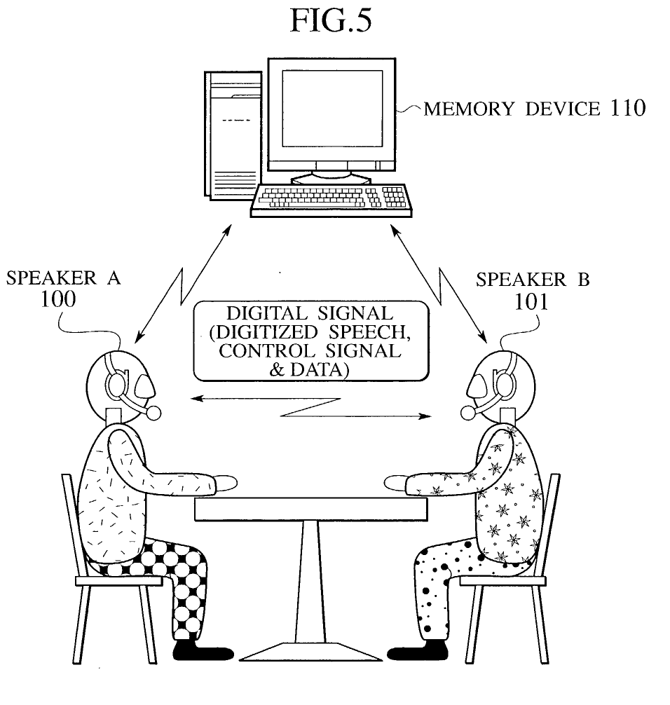

As indicated by the step S100, a scene in which a speaker A 100 and a speaker B 101 are carrying out dialogue (speech dialogue) will be considered. An exemplary dialogue scene is shown in FIG. 5. FIG. 5 shows a scene in which two persons wearing headset type microphones are conversing. By wearing the microphones in this way and recording the digitized speeches in a memory device 110 such as a hard disk of PC, it is possible to record all the speeches uttered by the persons. Although the headset type microphone is used in this example, there is no need for the microphone to be a headset type, and the other types of microphones such as a pin type microphone, a floor microphone, or a wall embedded type microphone can be used. Also, the memory device 110 can record the digital signals such as the digitized control signals and data, in addition to the digitized speeches.

First, in FIG. 4, suppose that a conference record or summary is to be produced from the recorded speech data. To this end, there is a need to convert the speech data into the text data. In FIG. 4, the case of converting the speech data 102 of the speaker A 100 is considered, but the speech data to be converted can be the speech data of the speaker B 101 or the speech data of both of the speaker A 100 and the speaker B 101.

At the step S101, the conversation speeches of the speaker A 100 are recorded, to produce the speech data 102. From the speech data 102, the acoustic model for recognition 105 is produced by the acoustic model production device 1 according to the present invention. The acoustic model for recognition 105 is used when a speech recognition unit 104 recognizes the speeches of the speaker A 100 and converts them into text data B 108. By carrying out the speech recognition by using the speech data 102 of the speaker A 100 and the acoustic model for recognition produced from the speech data 102 of the speaker A 100, it is possible to produce the text data B 108 more accurately. There is also an advantage in that it is efficient in the case of searching the recorded data later on, if the speech data are converted into the text data, and the speech data and the text data are set in correspondence, such that it is possible to search the speech data by using the text data.

Next, in a middle of the conversation of the speaker A 100 and the speaker B 101, as indicated by the step S102, suppose that text data A 103 such as a memo is to be inputted from a keyboard by the speaker A 100 and sent to the speaker B 101 by mail later on. The speaker B 101 wishes to read the mail while driving a car, so that he tries to convert the text data A 103 into the speech data by using a speech synthesis unit 107 and listen to it.

At this point, it gives a realistic feeling and helps the understanding if the mail is read by the voice of the speaker A 100 rather than the voice of a third person. In addition, in the case of using the voice of the same speaker A 100, it is even more preferable to read it by the voice of the speaker A 100 as heard at the time of the conversation of the speaker A 100 and the speaker B 101. This is because the human voice is changing everyday, and the manner of utterance changes largely depending on the conversing partner. It causes a strange feeling if it is read by the voice of the speaker A 100 ten years ago, and if the speaker A 100 and the speaker B 101 are friends, it causes a strange feeling if it is read by the voice as heard at the time the speaker A 100 has spoken with his superior at the company.

For this reason, the acoustic model for synthesis 106 is produced by the acoustic model production device 1 according to the present invention, by using the speech data 102 recorded at the time of the conversation of the speaker A 100 and the speaker B 101. Then, using this acoustic model for synthesis 106, the text data A 103 is converted into the speech data by the speech synthesis unit 107, and the speeches are outputted from a speech output unit 109. These speeches are given by the same voice as heard at the time of the conversation of the speaker A 100 and the speaker B 101.

Also, at a time of producing the acoustic model for synthesis 106, by extracting the phoneme information from the speech data 102 by using the acoustic model for recognition 105 produced in advance, it becomes possible to produce the acoustic model for synthesis more efficiently. In this way, the speech recognition and the speech synthesis are closely related to each other, so that by producing in advance the acoustic model for recognition 105 and the acoustic model for synthesis 106 from the same speech data 102, it becomes possible to considerably promote the secondary utilization of the recorded speeches and memos.

Besides that, by producing the acoustic model for recognition and the acoustic model for synthesis simultaneously, the simultaneously produced acoustic model for recognition can be used in extracting the phoneme information from the speech data at a time of producing the acoustic model for synthesis next time. In this way, it becomes possible to extract the phoneme information from the speech data at a higher precision than a previous time. When the phoneme information can be extracted at a good precision, the precision of the acoustic model for recognition and the acoustic model for synthesis can also be improved, and it becomes possible to realize the speech recognition at a higher precision and the speech synthesis with a good speech quality.

By repeating this series of processing, it becomes possible to produce the acoustic model for recognition and the acoustic model for synthesis with even higher performance. In addition, in order to produce the acoustic model for recognition and the acoustic model for synthesis in even better quality, there is a need to eliminate the phoneme information extraction error in the case of the automatic processing. To this end, the quality can be improved by the manual check of the data quality.

(Second Embodiment)

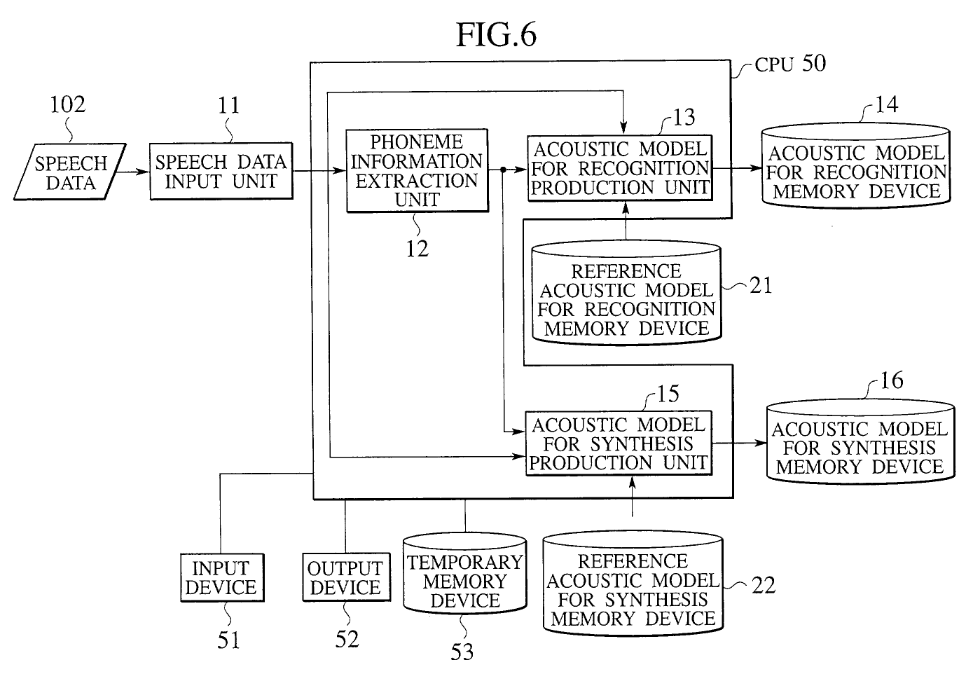

The acoustic model production device according to the second embodiment produces the acoustic model for recognition and the acoustic model for synthesis simultaneously by utilizing the acoustic model for recognition and the acoustic model for synthesis that were produced in the past. As shown in FIG. 6, the acoustic model production device according to the second embodiment has a speech data input unit 11 for inputting speech data 102, a CPU (processing control device) 50, an input device 51 connected to the CPU 50, an output device 52, a temporary memory device 53, an acoustic model for recognition memory device 14, an acoustic model for synthesis memory device 16, a reference acoustic model for recognition memory device 21, and a reference acoustic model for synthesis memory device 22. The CPU 50 has a phoneme information extraction unit 12, an acoustic model for recognition production unit 13, and an acoustic model for synthesis production unit 15.

The input device 51, the output device 52, the temporary memory device 53, the speech input unit 11, and the phoneme information extraction unit 12 are the same as those of the acoustic model production device according to the first embodiment, so that their description will be omitted here.

The acoustic model for recognition production unit 13 newly learns the acoustic model for recognition from the speech data 102, the phoneme information, and the acoustic model for recognition produced in the past and stored in the reference acoustic model for recognition memory device 21. There are many methods available as the acoustic model for recognition learning method, depending on the scheme of the acoustic model, such as the well known Baum-Welch algorithm in the case of using HMM, for example.

The acoustic model for recognition memory device 14 stores the acoustic model for recognition produced by the acoustic model for recognition production unit 13. The acoustic model for recognition stored in the acoustic model for recognition memory device 14 is copied to the reference acoustic model for recognition memory device 21, and can be used in the next production of the acoustic model for recognition. The acoustic model for recognition memory device 14 and the reference acoustic model for recognition memory device 21 can be realized in various media such as semiconductor memory, hard disk, and DVD, but a specific form of the media to be used is not relevant here.

The acoustic model for synthesis production unit 15 newly produces the acoustic model for synthesis from the speech data 102, the phoneme information, and the acoustic model for synthesis produced in the past and stored in the reference acoustic model for synthesis memory device 22. What is to be produced can be different depending on the acoustic model to be used for the speech synthesis. For example, the phonemic element, fundamental pitch, sound source residual, meter information, etc., are produced for the inputted speech data.

The acoustic model for synthesis memory device 16 stores the acoustic model for synthesis produced by the acoustic model for synthesis production unit 15. The acoustic model for synthesis stored in the acoustic model for synthesis memory device 16 is copied to the reference acoustic model for synthesis memory device 22, and can be used in the next production of the acoustic model for synthesis. The acoustic model for synthesis memory device 16 and the reference acoustic model for synthesis memory device 22 can be realized in various media such as semiconductor memory, hard disk, and DVD, but a specific form of the media to be used is not relevant here.

According to the acoustic model production device of the second embodiment, the new acoustic model for recognition and the new acoustic model for synthesis are produced by using the acoustic model for recognition and the acoustic model for synthesis that were produced in the past, so that it is possible to produce the acoustic model for recognition and the acoustic model for synthesis with the gradually improved performance, without preparing a large amount of speech data at once.

(Third Embodiment)

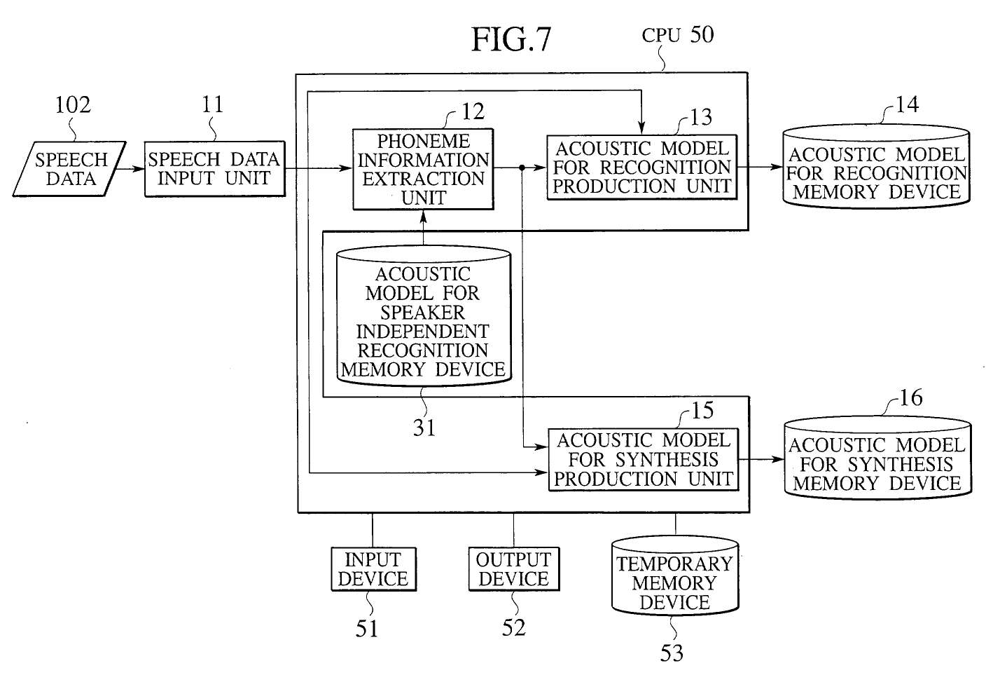

The acoustic model production device according to the third embodiment produces the acoustic model for recognition and the acoustic model for synthesis simultaneously, by utilizing the acoustic model for speaker independent recognition. As shown in FIG. 7, the acoustic model production device according to the third embodiment has a speech data input unit 11 for inputting speech data 102, a CPU (processing control device) 50, an input device 51 connected to the CPU 50, an output device 52, a temporary memory device 53, an acoustic model for recognition memory device 14, an acoustic model for synthesis memory device 16, and an acoustic model for speaker independent recognition memory device 31. The CPU 50 has a phoneme information extraction unit 12, an acoustic model for recognition production unit 13, and an acoustic model for synthesis production unit 15.

The input device 51, the output device 52, the temporary memory device 53, the speech input unit 11, the acoustic model for recognition production unit 13, the acoustic model for recognition memory device 14, the acoustic model for synthesis production unit 15, and the acoustic model for synthesis memory device 16 are the same as those of the acoustic model production device according to the first embodiment, so that their description will be omitted here.

The phoneme information extraction unit 12 uses the acoustic model stored in the acoustic model for speaker independent recognition memory device 31 at a time of extracting the phoneme information from the speech data. The acoustic model for speaker independent recognition is an acoustic model for recognition produced from voices of many people, rather than an acoustic model for recognition produced in accordance with the voice of a specific person. The phoneme information extraction unit 12 carries out the phoneme extraction processing efficiently by utilizing the acoustic model for speaker independent recognition, even when there is no acoustic model for recognition produced from the speeches of a specific person in the past.

Also, similarly as the phoneme information extraction unit 12 of the acoustic model production device according to the first embodiment, the more detailed phoneme information extraction can be carried out even though it requires more processing time to improve the precision of the phoneme extraction, or the information of a portion that is judged as incorrect can be set as not to be used. Also, the automatically extracted result can be displayed at the output device 52, and only the correctly extracted phoneme information can be selected by manually checking the automatically extracted result by using the input device 51.

According to the acoustic model production device of the third embodiment, it becomes possible for the phoneme information extraction unit 12 to carry out the phoneme extraction processing efficiently by utilizing the acoustic model stored in the acoustic model for speaker independent recognition memory device 31, even when there is no acoustic model for recognition produced from the speeches of a specific person in the past.

(Fourth Embodiment)

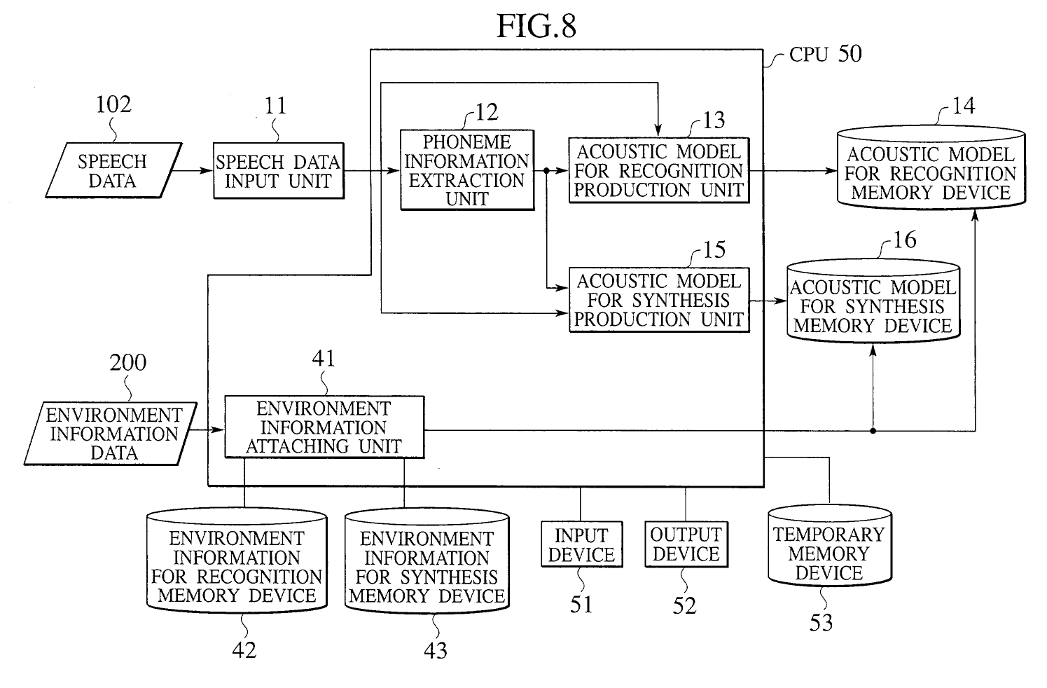

The acoustic model production device according to the fourth embodiment produces the acoustic model for recognition and the acoustic model for synthesis simultaneously, while attaching environment information to the produced acoustic model for recognition and acoustic model for synthesis. As shown in FIG. 8, the acoustic model production device according to the fourth embodiment has a speech data input unit 11 for inputting speech data 102, a CPU (processing control device) 50, an input device 51 connected to the CPU 50, an output device 52, a temporary memory device 53, an acoustic model for recognition memory device 14, an acoustic model for synthesis memory device 16, an environment information for recognition memory device 42, and an environment information for synthesis memory device 43. The CPU 50 has a phoneme information extraction unit 12, an acoustic model for recognition production unit 13, an acoustic model for synthesis production unit 15, and an environment information attaching unit 41.

The input device 51, the output device 52, the temporary memory device 53, the speech input unit 11, the phoneme information extraction unit 12, the acoustic model for recognition production unit 13, the acoustic model for recognition memory device 14, the acoustic model for synthesis production unit 15, and the acoustic model for synthesis memory device 16 are the same as those of the acoustic model production device according to the first embodiment, so that their description will be omitted here.

The environment information attaching unit 41 attaches environment information data 200 of the time when the speech inputted into the speech data input unit 11 is uttered, to the acoustic model for recognition and the acoustic model for synthesis produced from that speech data.

More specifically, the environment information data can be a time information, a place information, a speaker's physical condition, a conversing partner of the speaker, etc. As the environment information data input method, the speaker can input it at a time of the speech input, a time information can be automatically input by using a clock, and a place information can be automatically input by using GPS, for example. It is also possible to measure the fluctuation of the sound wave, the blood pressure, the pulse, the body temperature, the perspiration, the speech volume, etc., and attach the feeling and the biological information of the speaker as the environment information.

Besides these, it is also possible to register the schedule of the speaker in advance, and attach the environment information data regarding whether the current location is inside the company or inside the home, whether it is during the conference or during the meal, etc., according to the time zone at which the speech is inputted. In addition, even when the environment information data are not inputted at a time of the speech data input, it is possible to attach the environment information data by extracting the emotion information regarding whether the speaker is talking joyfully or not, etc., according to the content of the speech, the voice pitch, the volume, etc., of the inputted speech data.

The environment information for recognition memory device 42 stores the environment information data to be attached to the acoustic model for recognition. Also, the environment information for synthesis memory device 43 stores the environment information data to be attached to the acoustic model for synthesis.

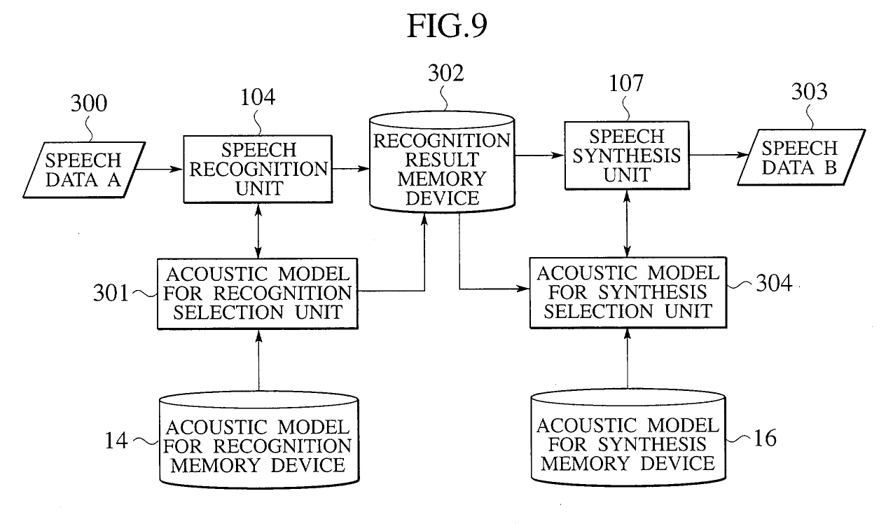

Next, an exemplary way of utilizing the acoustic model for recognition and the acoustic model for synthesis produced by the acoustic model production device according to the fourth embodiment will be described with reference to FIG. 9. FIG. 9 shows the exemplary case of the speech recognition and speech synthesis processing utilizing the acoustic model for recognition or the acoustic model for synthesis selected according to the environment information data. The acoustic model for recognition and the acoustic model for synthesis produced by the acoustic model production device according to the fourth embodiment are respectively stored in the acoustic model for recognition memory device 14 and the acoustic model for synthesis memory device 15.

The speech recognition unit 104 recognizes the speech data A 300, and convert them into the text data. At this point, in order to convert them into the text data that are in accordance with the environment information of the time when the speech data A 300 are uttered, the acoustic model for recognition selection unit 301 selects the acoustic model for recognition according to the environment information, from the acoustic model for recognition memory device 14. the speech recognition unit 104 converts the speech data A 300 into the text data by using the selected acoustic model for recognition. Then, the text data are stored into the recognition result memory device 302 along with the environment information data selected by the acoustic model for recognition selection unit 301.

The speech synthesis unit 107 converts the text data stored in the recognition result memory device 3023 into the speech data B 303. At this point, the acoustic model for synthesis selection unit 304 selects the acoustic model for synthesis from the acoustic model for synthesis memory device 16, by using the environment information data stored in the recognition result memory device 302. The speech synthesis unit 107 converts the text data into the speech data B 303 by using the acoustic model for synthesis selected by the acoustic model for synthesis selection unit 304.

According to the acoustic model production device of the fourth embodiment, it becomes possible to selectively use the acoustic model for recognition and the acoustic model for synthesis, according to the environment information regarding the environments for using the acoustic model for recognition and the acoustic model for synthesis.

As described, according to the present invention, it is possible to provide an acoustic model production device and an acoustic model production method capable of simultaneously producing the acoustic model for recognition and the acoustic model for synthesis in good quality.

Note that, in the first to fourth embodiments of the present invention, the acoustic model for recognition memory device 14 and the acoustic model for synthesis memory device 15 are described as separate memory devices, but it is also possible to store the acoustic model for recognition and the acoustic model for synthesis in a single memory device. Similarly, in the fourth embodiment, the environment information for recognition memory device 42 and the environment information for synthesis memory device 43 are described as separate memory devices, but it is also possible to store the environment information for recognition and the environment information for synthesis in a single memory device.

Note also that, in the first to fourth embodiments of the present invention, the acoustic model production device and the acoustic model production method for simultaneously producing the acoustic model for recognition and the acoustic model for synthesis have been described, but this “simultaneously producing” does not imply that they are produced at the same timing instantaneously, but it rather implies that the acoustic model for recognition and the acoustic model for synthesis are produced from the same speech data. Consequently, the order for producing the acoustic model for recognition and the acoustic model for synthesis can be changed.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An acoustic model production device, comprising:
a speech data input unit configured to input speech data;
a phoneme information extraction unit configured to extract phoneme information from the speech data, and set the speech data and the phoneme information in correspondence;
an acoustic model for recognition production unit configured to learn an acoustic model for recognition from the speech data and the phoneme information; and
an acoustic model for synthesis production unit configured to produce an acoustic model for synthesis from the speech data and the phoneme information.

2. The acoustic model production device of claim 1, wherein the acoustic model for recognition production unit newly learns the acoustic model for recognition from the speech data, the phoneme information, and another acoustic model for recognition produced in past; and
the acoustic model for synthesis production unit newly produces the acoustic model for synthesis from the speech data, the phoneme information, and another acoustic model for synthesis produced in past.

3. The acoustic model production device of claim 1, wherein the phoneme information extraction unit extracts the phoneme information from the speech data by using an acoustic model for speaker independent recognition.

4. The acoustic model production device of claim 1, further comprising:
an environment information attaching unit configured to attach environment information data of a time at which the speech data is uttered, to the acoustic model for recognition or the acoustic model for synthesis.

5. The acoustic model production device of claim 4, wherein the environment information attaching unit attaches the environment information data that indicates at least one of a time and a place at which the speech data is uttered, a conversing partner, information regarding a physical condition of a speaker, information regarding a feeling of the speaker, and information regarding a schedule of the speaker.

6. The acoustic model production device of claim 1, further comprising:
an output device configured to display the phoneme information extracted by the phoneme information extraction unit; and
an input device configured to select only the phoneme information that is extracted correctly.

7. An acoustic model production method, comprising:
inputting speech data;
extracting phoneme information from the speech data, and setting the speech data and the phoneme information in correspondence;
learning an acoustic model for recognition from the speech data and the phoneme information; and
producing an acoustic model for synthesis from the speech data and the phoneme information.

8. The acoustic model production method, wherein the extracting step extracts the phoneme information by using the acoustic model for recognition learned by the learning step.

9. The acoustic model production method, further comprising:
judging whether there is any error in the phoneme information extracted by the extracting step or not.
